(19) United States
(12) Patent Application Publication
(10) Pub. No.: US 2010/0046716 A1
(43) Pub. Date: Feb. 25, 2010

(54) X-RAY TUBE WITH BACKSCATTER PROTECTION

(76) Inventor: Joerg Freudenberger, Kalchreuth (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/542,859

(22) Filed: Aug. 18, 2009

(30) Foreign Application Priority Data
Aug. 20, 2008 (DE) 10 2008 038 569.7

(51) Int. Cl. H01J 35/18

(52) U.S. Cl. 378/140

(57) ABSTRACT

An x-ray tube has a vacuum housing containing an anode that generates usable x-ray radiation upon being struck by electrons generated by an electron source. The usable x-ray radiation escapes from the vacuum housing through an x-ray exit window. A backscatter electron barrier device arranged in the vacuum housing affects the backscatter electrons in the region of the usable x-ray radiation such that no backscatter electrons reach the x-ray exit window. Such an x-ray tube exhibits an invariably constant x-ray intensity and a high reliability.

### BACKGROUND OF THE INVENTION

1. Field of the Invention

The present invention concerns an x-ray tube with a vacuum housing in which an anode is arranged that generates x-ray radiation upon being struck by electrons generated by an electron source, the x-ray radiation exiting the vacuum housing through an x-ray exit window.

2. Description of the Prior Art

The generation of x-ray radiation in x-ray tubes typically ensues by bombardment of an anode with free electrons. The electrons are released from a cathode (thermionic emitter, field emitter) and accelerated to the desired primary energy by high voltage that is applied between the cathode and the anode. Upon the electrons striking the anode, the kinetic energy of the electrons is partially converted into x-ray radiation by the interaction of the electrons with the atomic nuclei of the anode. The yield of the generated x-ray radiation, i.e. the number of x-ray quanta over the entire energy range, exhibits a nearly linear dependency on the atomic number of the anode material that is used.

For correct functioning, the entire arrangement must be contained in a vacuum housing (vacuum casing). The vacuum housing typically is formed of metal and/or a vacuum-sealed insulator, for example glass or ceramic. Depending on the configuration of the tube, the vacuum housing is connected with the anode (and therefore is at the same potential as the anode) or is insulated from the anode and the cathode (and then typically lies at a potential near to ground).

The x-ray radiation designated for use (usable x-ray radiation) should optimally be able to leave the arrangement without losses. For this purpose, an x-ray exit window made of an x-ray-transparent material is integrated into the vacuum housing. Since, as part of the vacuum housing, this x-ray exit window must also satisfy specific requirements with regard to mechanical stability, and a connection engineering and vacuum seal that satisfy regulatory standards, often a compromise with regard to the optimal satisfaction of all required properties must be made in the material selection. While in older x-ray tubes the vacuum housing (or at least a majority of this) is produced from glass, in modern x-ray tubes the vacuum housing is often made of metal and an x-ray exit window made of an x-ray-transparent material is located only in the region of the exit of the usable x-ray radiation from the x-ray tube. In the “Straton” type rotating piston x-ray tube from Siemens, it is known to produce the x-ray exit window with a lower wall thickness relative to the vacuum housing produced from steel. The usable x-ray radiation thus can exit largely unfiltered from the x-ray tube.

The focal spot or the focal path (rotating anode x-ray tube, rotating piston x-ray tube), thus the part of the anode at which the primary beam of the electrons strikes, also emits electrons. These are secondary electrons that are additionally released from the anode material by excitation processes as well as electrons of the primary beam that leave the anode again after elastic scattering or after inelastic scattering or excitation processes. The latter electrons are designated as backscatter electrons in the following.

At least some backscatter electrons still have a relatively high energy. If they strike adjacent parts of the vacuum housing, the exit window or the anode itself (this time outside of the actual focal spot), they generate a more or less strong x-ray radiation due to their high energy and depending on the material at the secondary impact point, and cause a heating of the material. In particular given high power x-ray tubes with vacuum housings made from a stable metal, the secondary impact points produce a non-negligible x-ray radiation that is designated as extra-focal radiation.

Moreover, the secondary impact point is in turn a source for backscatter and secondary electrons. The backscatter rate (thus the ratio of the number of re-emitted electrons to incident electrons) thereby varies with the atomic number Z of the struck material in a range from 0.2 at Z=10 to 0.5 at Z=50 (given an angle of incidence of the electrons of 40° relative to the surface normal). In particular, a considerable backscattering occurs at the impact point in high power x-ray tubes.

For example, this problem forms the basis for U.S. Pat. No. 7,260,181. The x-ray tube disclosed therein has a vacuum housing in which an x-ray exit window is installed in proximity to the anode surface, through which x-ray exit window the x-ray radiation emitted by the anode can pass. In addition to the vacuum housing and the transparent x-ray exit window, a layer with a material of high atomic number is applied in this region, in particular with an atomic number Z≧35. This material has a comparably high backscatter coefficient and has the effect that electrons that have been backscatter from the anode and would strike the vacuum housing in the region of the window are scattered back again for their part so that the heat load of the vacuum housing and of the x-ray exit window is reduced. However, the thermal engineering protection of the vacuum housing is inevitably in opposition to the additional heating of the anode, since some of the electrons scatted back from the layer strike the anode. More unwanted extra-focal radiation is also additionally generated by the layer, not only by the impact of the backscattered electrons on the layer with comparably high atomic number, but also by the new impact of multiple backscattered electrons on the anode.

If it is not masked by suitable countermeasures, the extra-focal radiation generated at the secondary impact points of the backscatter electrons leads to an (in part) significant degradation of the image quality that can be achieved with the x-ray tube. However, a subsequent masking of the extra-focal radiation requires an additional, not insignificant effort and can often not be implemented depending on the application field of the x-ray tube. This is particularly the case in applications that require a high exposure field and therefore can only be operated with a wide collimation, or in systems with variable focus position as they are used in high-resolution computer tomography.

Depending on the further path of the backscatter electrons, these can contribute to the heating of the anode in that they strike again at another point on the anode, for example, or are scattered back again from a secondary impact point and strike the anode. The problem of the anode heating is generally counteracted by an increase of the heat storage capability of the anode, by an optimally direct anode cooling and by the use of anode materials and connection techniques that allow an optimally high operating temperature of the anode structure. Here the requirement also exists to keep the heating of the anode as low as possible.

Due to the high temperature in the focal spot (approximately 2,600° C.) and the high kinetic energy of the electrons striking the anode (approximately 120 keV), positively charged ions (cations) escape from the material of the anode when the electrons strike said anode. The cations escaping from the anode are accelerated towards the cathode (lying at a negative potential) and strike this. When the cations strike the cathode, it can lead to impurities (contamination) and to direct mechanical damage. Due to their geometric shape and their delicate [filigree] structure (approximately 10 nm in diameter and a few μm in length), the impurities can moreover lead to additional damages in field emitters that are produced from carbon nanotubes. Even minor damage to the cathode leads to a degradation of the emission properties, and therefore to a degradation of the x-ray intensity. A more severe damage inevitably leads to a failure of the x-ray tube.

An x-ray tube with a backscatter electron capture device is known from United States Patent Application Publication No. 2008/0112538. The backscatter electron capture device possesses an electron absorption layer made from a material with a relatively low density and a relatively low atomic number of Z<50. The probability of a second scattering of backscatter electrons should be reduced with the backscatter electron capture device.

### SUMMARY OF THE INVENTION

An object of the present invention is to provide an x-ray tube with an invariably constant x-ray intensity and a high reliability.

The x-ray tube according to the invention has a vacuum housing in which is arranged an anode that generates usable x-ray radiation upon impact of electrons generated in an electron source (for example a cathode), which usable x-ray radiation exit from the vacuum housing through an x-ray exit window. According to the invention, a backscatter electron barrier device arranged in the vacuum housing acts on the backscatter electrons in the region of the usable x-ray radiation such that no backscatter electrons reach the x-ray exit window.

Approximately 50% of the electrons striking the anode—which electrons generate the primary x-ray beam (usable x-ray radiation)—are scattered back. Normally these backscatter electrons possess no pronounced preferential direction; thus they scatter approximately isotropically in all spatial directions.

Due to the backscatter electron barrier device arranged according to the invention in the vacuum housing, the backscatter electrons are prevented from reaching the x-ray exit window.

The isotropically propagating backscatter electrons (of which a large portion propagate in the direction of the x-ray exit window) are given a defined preferential direction due to the backscatter electron barrier device, such that they do not arrive at the x-ray exit window. For example, this can be achieved in that a corresponding electrical field and/or a corresponding magnetic field is additionally applied at the backscatter electron barrier device.

Because no backscatter electrons reach the x-ray exit window in the x-ray tube according to the invention, no x-ray radiation arises ether in the x-ray exit window.

An unwanted generation of extra-focal radiation in the volume penetrated by the usable x-ray radiation is reliably prevented by the barrier according to the invention.

A heating of the x-ray exit window due to striking backscatter electrons also does not occur given the solution according to the invention. A cooling of the x-ray exit window is thus not necessary in the x-ray tube according to the invention; the x-ray exit window can therefore exhibit a significantly smaller thickness. In the ideal case, the x-ray exit window is composed of only a thin layer (for example of tantalum).

Due to the smaller thickness of the x-ray exit window and the unnecessary cooling of the x-ray exit window, a higher intensity of the usable x-ray radiation is provided in the x-ray tube according to the invention.

The usable x-ray radiation generated in the anode does not strike backscatter electrons on its path to the x-ray exit window, such that no Compton scattering occurs at backscatter electrons. The intensity of the usable x-ray radiation is thus not negatively affected in the vacuum housing.

According to an embodiment of the x-ray tube according to the invention, the backscatter electron barrier device has a backscatter electron capture device. The backscatter electron capture device advantageously covers all solid angles that are not penetrated by usable x-ray radiation.

An additional advantageous embodiment of the x-ray tube according to the invention is characterized in that the backscatter electron capture device comprises a backscatter electron deflection unit.

For specific applications it can also be advantageous when the backscatter electron deflection unit lies at the potential of the electron source (cathode). The backscatter electrons reflected at the anode are then deflected in the direction of the backscatter electron capture device that lies at a potential that is positive relative to the potential of the electron source.

According to a preferred exemplary embodiment, the backscatter electron capture device of the x-ray tube comprises a backscatter electron stop.

In order to shield against the x-ray radiation that is generated upon impact of the backscatter electrons in the backscatter electron stop, the backscatter electron capture device advantageously comprises a shielding.

An additional advantageous embodiment is characterized in that the backscatter electron capture device comprises a backscatter electron collimator that is arranged between the anode and the backscatter electron deflection unit.

### BRIEF DESCRIPTION OF THE DRAWINGS

FIG. 1 shows a first embodiment of an x-ray tube according to the invention.

FIG. 2 shows a second embodiment of an x-ray tube according to the invention.

FIG. 3 shows a third embodiment of an x-ray tube according to the invention.

### DESCRIPTION OF THE PREFERRED EMBODIMENTS

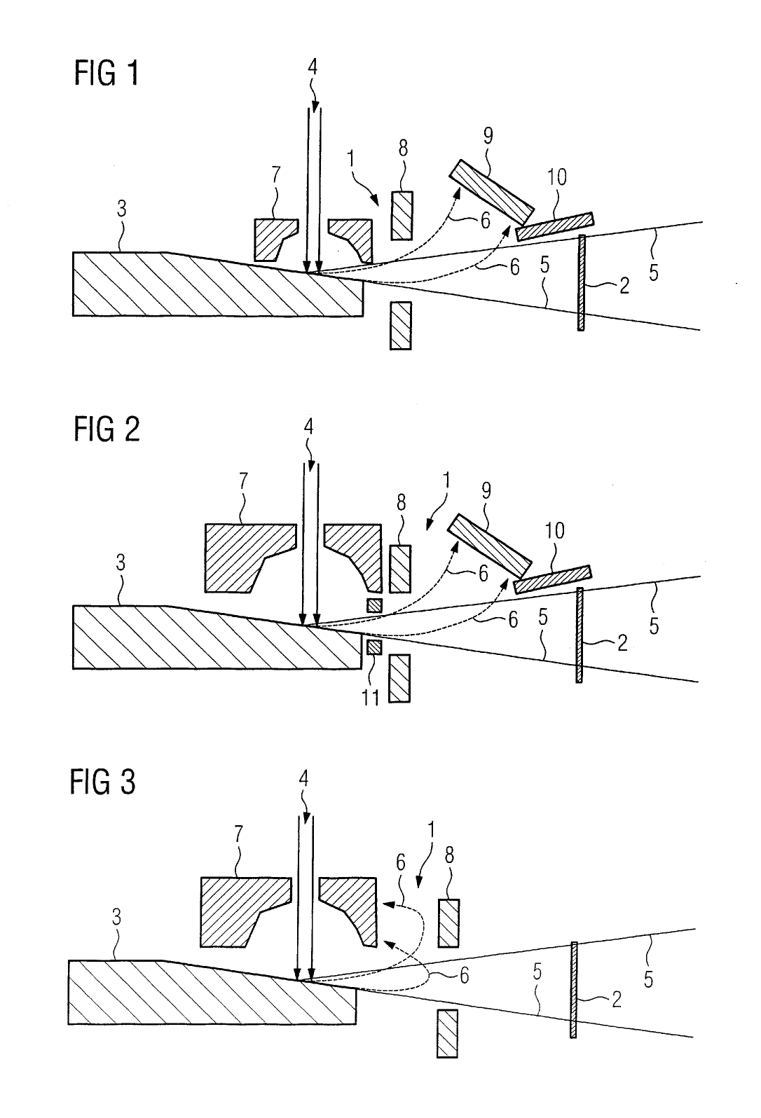

A backscatter electron capture device 1 that, according to the invention, is arranged in a vacuum housing of an x-ray tube is respectively shown in FIGS. 1 through 3 in the region of an x-ray exit window 2.

An anode 3 that generates usable x-ray radiation 5 upon impact of electrons 4 that were generated in an electron source (for example a cathode; not shown in FIGS. 1 through 3) is respectively arranged in the vacuum housing, which usable x-ray radiation 5 exits from the vacuum housing through the x-ray exit window 2.

Approximately 50% of the electrons 4 striking the anode 3 (which electrons generate the usable x-ray radiation) are scattered back. In the following these electrons are designated as backscatter electrons 6. Normally the backscatter electrons 6 possess no pronounced preferential direction; thus they scatter approximately isotropically in all spatial directions.

The backscatter electron capture device 1 respectively shown in FIGS. 1 through 3 affect the backscatter electrons 6 in the region of the usable x-ray radiation 5 such that no backscatter electrons 6 reach the x-ray exit window 2.

The electrons scattered back by the anode 3 (backscatter electrons 6) can lead to a degradation of the image quality in both thermionic emitters and field emitters since the backscatter electrons 6 can reach the anode 3 again. The backscatter electrons 6 are unfocused and possess no defined kinetic energy. The backscatter electrons 6 with low kinetic energy merely feed thermal energy into the anode 3, in contrast to which the backscatter electrons 6 with sufficiently high kinetic energy can generate an unwanted extra-focal radiation.

In the x-ray tubes shown in FIGS. 1 through 3, the backscatter electron barrier device 1 respectively have a backscatter electron capture device 7. The backscatter electron capture device 7 covers all solid angles that are not penetrated by usable x-ray radiation 5.

The backscatter electron barrier device 1 furthermore includes a backscatter electron deflection unit 8.

In the exemplary embodiment according to FIG. 3, the backscatter electron deflection unit 8 lies at the potential of the electron source (cathode). The backscatter electrons 6 reflected at the anode 3 are then deflected in the direction of the backscatter electron capture device 7 that lies at a potential that is positive relative to the potential of the electron source.

The backscatter electron barrier devices shown in FIGS. 1 and 2 furthermore respectively have a backscatter electron stop 9. The embodiment shown in FIG. 3 does not require any backscatter electron stop since backscatter electron deflection unit 8 deflects all backscatter electrons 6 in the direction of the backscatter electron capture device 7 due to its potential, and therefore no backscatter electrons 6 move through the backscatter electron deflection unit 8 into the region of the usable x-ray radiation 7.

In order to shield against the x-ray radiation that is generated upon impact of the backscatter electrons 6 in the backscatter electron stop 9, the backscatter electron barrier device 1 in the embodiments according to FIGS. 1 and 2 has a shielding 10.

In order to attain an improved guidance of the backscatter electrons 6 in the backscatter electron barrier device 1, a backscatter electron collimator 11 is arranged between the anode 3 and the backscatter electron deflection unit 8 in the embodiment shown in FIG. 2.

As is apparent from the exemplary embodiments according to FIGS. 1 through 3, the isotropically flying backscatter electrons 6 (of which a large proportion initially propagates in the direction of the x-ray exit window 2) receive a defined preferential direction due to the backscatter electron barrier device 1, such that they do not reach the x-ray exit window 2. for example, this can be achieved by applying a suitable electrical field and/or a suitable magnetic field additionally to the backscatter electron barrier device 1, and/or by one of these fields being generated by the backscatter electron barrier device 1 itself.

Because no backscatter electrons 6 reach the x-ray exit window 2 in the x-ray tube according to the invention, no x-ray radiation arises either in the x-ray exit window 2.

An unwanted generation of extra-focal radiation in the volume penetrated by the usable x-ray radiation 5 is reliably prevented by the measures according to the invention that are explained with regard to the examples.

A heating of the x-ray exit window 2 due to striking backscatter electrons 6 also does not occur given the solution according to the invention. A cooling of the x-ray exit window 2 is thus not necessary; the x-ray exit window 2 can therefore have a significantly smaller thickness. In the ideal case, the x-ray exit window 2 is formed only of a thin layer, for example of tantalum.

Due to the smaller thickness of the x-ray exit window 2 and the superfluous cooling of the x-ray exit window 2, a higher intensity of usable x-ray radiation 5 is provided in such an x-ray tube.

The usable x-ray radiation 5 generated in the anode 3 does not strike backscatter electrons 6 on its path to the x-ray exit window 2, such that no Compton scattering on backscatter electrons 6 occurs. The intensity of the usable x-ray radiation 5 is thus not negatively affected in the vacuum housing.

Although modifications and changes may be suggested by those skilled in the art, it is the intention of the inventor to embody within the patent warranted hereon all changes and modifications as reasonably and properly come within the scope of his or her contribution to the art.

I claim as my invention:

1. An x-ray tube comprising:
a vacuum housing;
a cathode disposed in said vacuum housing that emits electrons;
an anode in said vacuum housing that emits useable x-ray radiation upon being struck by said electrons, and that also emits backscatter electrons, simultaneously with emitting said useable x-ray radiation, upon being struck by said electrons emitted by said cathode;
said vacuum housing comprising an x-ray exit window, comprised of materials substantially transparent to said useable x-ray radiation, through which said useable x-ray radiation exits said vacuum housing; and
a backscatter electron barrier device disposed in said vacuum housing, that interacts with said backscatter electrons in a region of said useable x-ray radiation in said vacuum housing to cause substantially none of said backscatter electrons to reach said x-ray exit window.

2. An x-ray tube as claimed in claim 1 wherein said backscatter electron barrier device comprises a backscatter electron capture device.

3. An x-ray tube as claimed in claim 2 wherein said backscatter electron capture device has a size and shape encompassing all solid angles in said vacuum housing that are not penetrated by said useable x-ray radiation.

4. An x-ray tube as claimed in claim 1 wherein said backscatter electron barrier device comprises a backscatter electron deflection device.

5. An x-ray tube as claimed in claim 4 wherein said cathode is at a cathode potential, and wherein said backscatter electron deflection device is at said cathode potential.

6. An x-ray tube as claimed in claim 1 wherein said backscatter electron barrier device comprises a backscatter electron stop.

7. An x-ray tube as claimed in claim 6 wherein said backscatter electron barrier device comprises a shielding.

8. An x-ray tube as claimed in claim 1 wherein said backscatter electron barrier device comprises a backscatter electron deflection device and a backscatter electron collimator, said backscatter electron collimator being located between said anode and said backscatter electron deflection device.
